(19) United States
(12) Patent Application Publication
(10) Pub. No.: US 2026/0329928 A1
(43) Pub. Date: Oct. 22, 2026

(54) EmotionOS™: Emotion & Logic-Driven Multimedia Sequencing System and Method of Transmedia Arc Generation

(71) Applicants: Adam Layne Fisher, Simpsonville, SC (US); Megan Fisher, Simpsonville, SC (US)

(72) Inventors: Adam Layne Fisher, Simpsonville, SC (US); Megan Fisher, Simpsonville, SC (US)

(73) Assignee: NGMco, Simpsonville, SC (US)

(21) Appl. No.: 19/216,668

(22) Filed: May 22, 2025

(51) Int. Cl. G06F 16/435

(52) U.S. Cl. CPC G06F 16/435

(57) ABSTRACT

A system and method for generating emotionally and/or logically structured multimedia sequences across digital content formats. The system accepts multimodal inputs, including natural language, symbolic, aesthetic, or emotional prompts. A natural language processing engine extracts tone, intent, and experiential goals, enabling a sequencing engine to construct coherent emotional or logical arcs without relying on prior user behavior, metadata, or engagement history. Output sequences are structured (e.g., JSON, XML) for external playback systems but do not directly initiate playback. An optional augmentation layer may append non-media actions such as breathwork, journaling, or environmental cues to enhance emotional resonance or closure. The system supports cold-start operation, nonlinear narrative paths, and modular integration into third-party platforms or services.

### FIELD OF THE INVENTION

The present invention relates to intelligent content sequencing and media recommendation systems. More specifically, it pertains to systems and methods for generating emotionally and/or logically structured multimedia sequences across diverse digital formats, including music, video, podcasts, and more. The invention enables the interpretation of emotionally expressive, poetic, symbolic, or logically structured input, regardless of syntax or formality, to produce coherent, narrative-based content arcs using natural language processing (NLP), emotional/cognitive trajectory mapping, and structured output logic. The system functions without reliance on user history, behavioral profiling, or traditional metadata, and may optionally include non-media action elements (e.g., breathwork or journaling prompts) designed to facilitate emotional resonance, closure, or psychological integration.

### BACKGROUND

Contemporary media platforms such as Spotify, Apple Music, Amazon Prime, Netflix, and YouTube rely heavily on keyword-based search, metadata tagging, genre classification, and historical user behavior to recommend content. These systems prioritize surface-level personalization, often recycling user preferences and engagement history, rather than interpreting user input with emotional or symbolic depth.

As a result, users experience fragmented, emotionally inconsistent, or cognitively dissonant content journeys. The problem is amplified by the fragmentation of content ecosystems, forcing users to manually curate their own narrative or emotional arcs across disparate services and formats.

There exists a critical need for a unified system capable of interpreting expressive input, be it emotional, symbolic, narrative, or logical, and dynamically generating multimedia arcs that support cold-start use cases and emotionally relevant experiences. This invention addresses that need by eliminating reliance on prior user data or platform-specific taxonomies, and by enabling narrative-driven output with or without supplemental behavioral feedback. The system may enhance personalization over time but is fully functional from the first prompt.

### SUMMARY OF THE INVENTION

The present invention discloses EmotionOS, an operating system and framework for generating emotionally and/or logically structured multimedia sequences based on symbolic, poetic, emotionally expressive, aesthetic, and/ or cognitively structured user input. The system is designed to operate across one or more media formats, such as music, video, podcasts, audiobooks, or other digital assets, without requiring prior user history, content metadata, or engagement profiling.

The system comprises the following core components:

User Input Interface: Accepts emotionally expressive and/or logically structured input via natural language, symbolic phrases, or multimodal formats (e.g., text, voice, image, or emotion-rich signals).

Natural Language Processing and Inference Engine: Parses user input to extract emotional tone, logical structure, symbolic meaning, narrative intent, and desired experiential outcome.

Content Sequencing Engine: Selects and arranges relevant content assets into emotionally or logically coherent arcs using proprietary sequencing logic, including emotional progression modeling, thematic weighting, and psychological pacing.

Output Module: Delivers structured output, such as JSON, XML, or proprietary schema, compatible with third-party playback systems, streaming APIs, or embedded environments. Playback is not initiated directly by the system.

Optional Ritual Augmentation Layer: Appends non-media suggestions, such as breathwork, journaling, mindfulness cues, or symbolic actions, to support emotional closure, narrative integration, or cognitive transformation.

The system is explicitly designed to operate in cold-start conditions, enabling immediate and contextually relevant output sequences without dependency on historical data. Emotional arcs may span a single format or integrate across multiple media types for transmedia narrative cohesion.

EmotionOS is modular and embeddable via SDK/API, making it suitable for integration into third-party platforms, applications, or devices. Its flagship embodiment, NARRATV, represents a working interactive interface that demonstrates live emotional arc generation and nonlinear storytelling logic.

The system is LLM-agnostic, supporting integration with large language models via external APIs, local inference, or proprietary models. In its embedded form, EmotionOS functions as a Unified Nonlinear Streaming Engine, enabling:

Creator-defined or AI-suggested narrative branching

Platform-curated nonlinear collections based on user input

Personalized media journeys anchored in emotional or cognitive prompts

This architecture enables EmotionOS to unify fragmented media ecosystems and deliver emotionally attuned, cognitively resonant, narrative-based experiences across entertainment, therapeutic, educational, and storytelling applications.

Emerging prompt-based playlist features from music streaming platforms (e.g., Spotify DJ) offer mood-themed curation but lack structured emotional arc generation, narrative coherence, or symbolic interpretation. EmotionOS addresses these limitations through cold-start, multimodal sequencing aligned to inferred psychological intent.

### BRIEF DESCRIPTION OF DRAWINGS

FIG. 1 illustrates an example interface embodiment of the EmotionOS system, including an action button (100), an input field (101), a summary/output overview region (102), one or more output item cards (103), and one or more media type indicators (104).

FIG. 2 illustrates an example system flowchart of the EmotionOS system, including a user input interface (201), a natural language processing and emotional inference module (202a), a tagging and content structuring layer (202b), a sequence generation engine (202c), an optional smart playback controller (202d), an output interface (203), an optional behavioral feedback module (204), an optional AI curator engine (205), and an optional dynamic prompt interface (206).

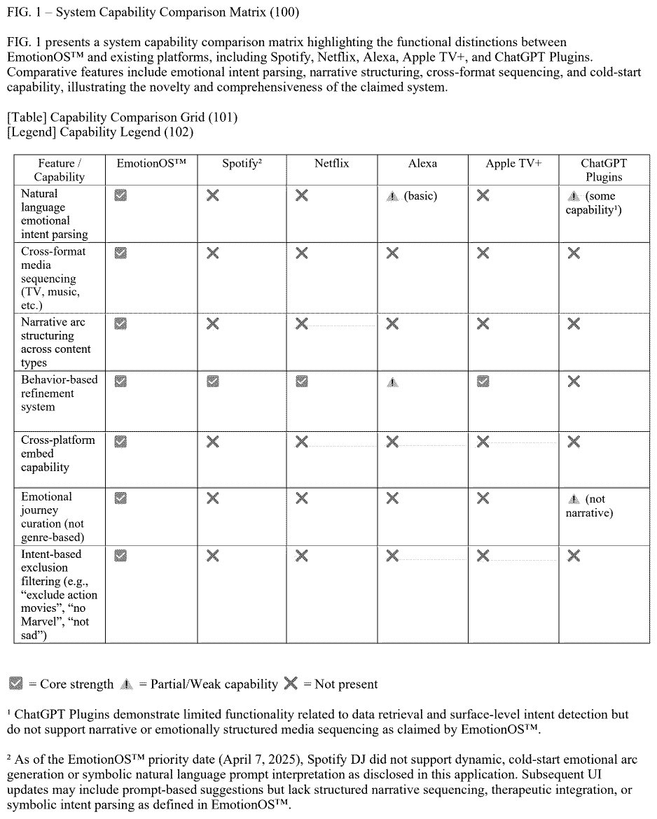

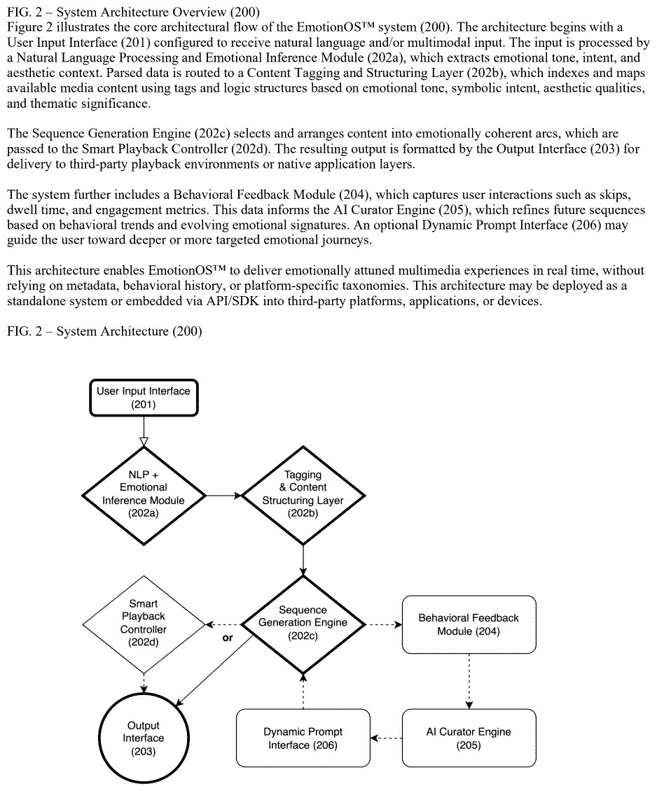

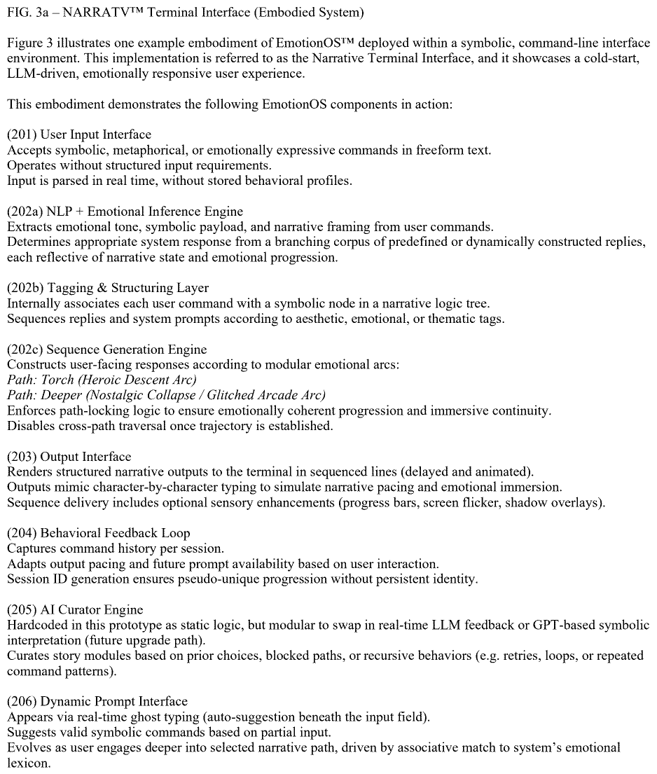

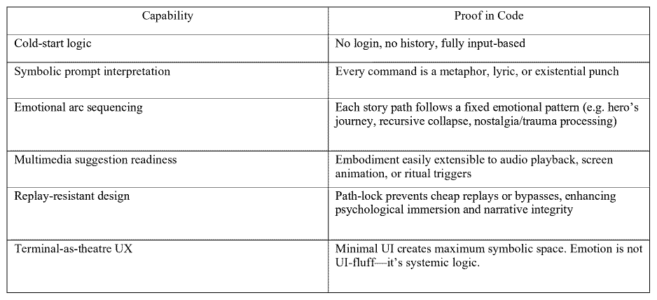

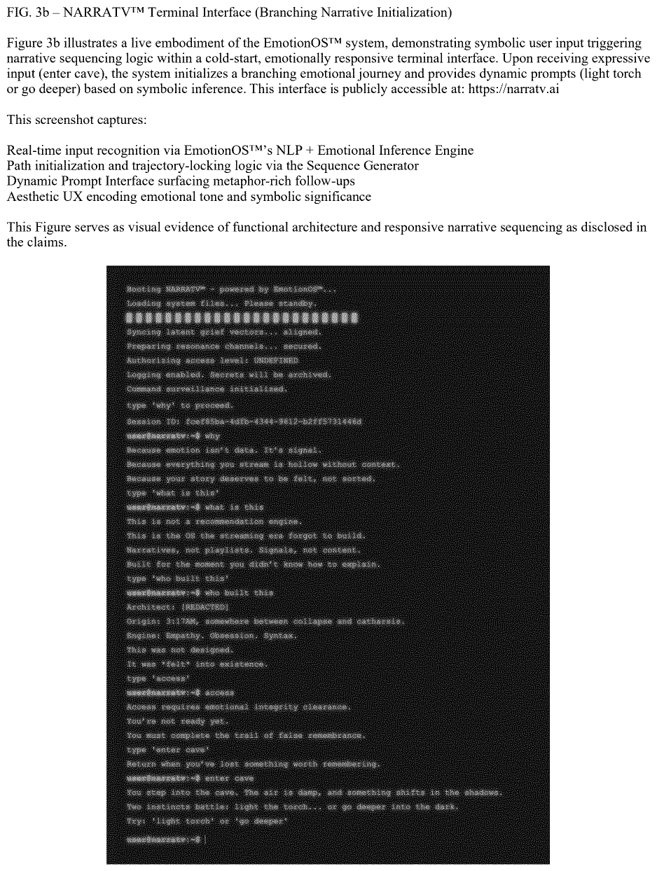

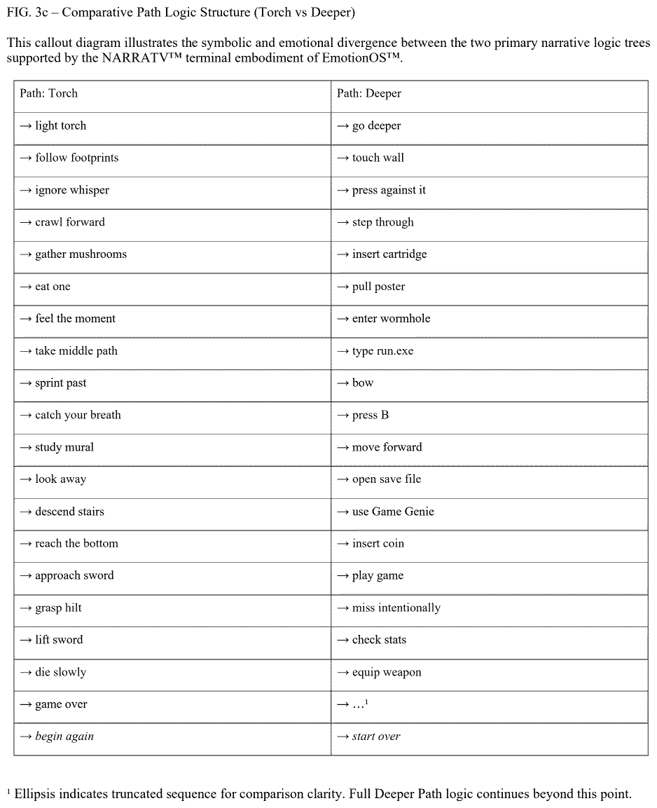

### DETAILED DESCRIPTION OF THE INVENTION

The present invention, referred to as EmotionOS, comprises a modular system designed to interpret emotionally and/or logically expressive input and generate structured multimedia sequences reflecting emotional arcs, cognitive journeys, or narrative trajectories. The system functions without requiring user history, metadata, or behavioral profiling and is capable of cold-start operation.

### System Components

The system comprises multiple modular components that work together to perform expressive input interpretation, sequencing, inference, and output generation.

### 1. User Input Interface (201)

The system includes a multimodal input interface configured to receive a wide range of user inputs, including but not limited to:
Free-form text
Spoken language via voice transcription
Emoji sequences
Images and video content
Aesthetic descriptors
Symbolic references
Stream-of-consciousness or structured queries
The interface is adaptable and extensible as large language model (LLM) technologies evolve

### 2. Natural Language Processing & Emotional Inference Layer (202a)

Input is parsed by a natural language processing module capable of:
Extracting emotional tone, mood state, symbolic meaning, logical framing, and psychological intent
Determining desired experiential outcomes (e.g., catharsis, uplift, closure)
Supporting high linguistic variance, including metaphorical language, emotional abstractions, or literal commands

This module may utilize transformer-based LLMs, proprietary inference engines, or third-party NLP services

### 3. Tagging & Content Structuring Layer (202b)

Content is indexed and mapped across emotional and symbolic dimensions, using tags such as:
Emotional signature
Narrative arc position
Character trajectory
Aesthetic texture
Genre or media format
Symbolic themes

This layer optionally integrates historical response data but is fully functional without it

### 4. Sequence Generation Engine (202c)

This core component arranges content assets into emotionally coherent arcs using multiple proprietary logic systems:
EAS: Emotional Arc Sequencing (e.g., despair to tension to catharsis to resolution)
TWM: Thematic Weighting Matrix
OCF: Omni-Directional Chronology Framework for nonlinear narratives
PAV: Predictive Adjustment Vector for behavioral refinement

### 5. Playback Output Interface (203)

The system outputs machine-readable sequences in formats such as:
JSON
XML
Proprietary schemas

### 6. Ritual Augmentation Layer (Optional)

This component appends non-media actions that enhance emotional impact and cognitive processing, such as:
Breathwork or breathing patterns
Journaling prompts or reflection tasks
Physical gestures or rituals
Environmental adjustments (lighting, scent, posture)
Symbolic or narrative-completion actions

This layer supports integration into wellness, therapeutic, or introspective applications and can function as a digital-to-physical bridge for embodiment and narrative closure

### 7. Behavioral Feedback Loop (Optional) (204)

The system optionally captures real-time and long-term behavioral signals, such as:
Skip frequency
Dwell time
Replay incidence
Session timing or user drop-off

This data is fed into the AI Curator Engine (205), which dynamically adjusts sequencing, pacing, and prompt structures to improve alignment with user patterns and inferred emotional needs

### 8. AI Curator Engine (205)

The AI Curator continuously refines system output by:
Reweighting emotional or symbolic tags
Adapting the sequencing logic based on interaction data
Personalizing prompt suggestions and future content arcs

The engine operates across sessions and can support personalization without requiring persistent user identity

### 9. Dynamic Prompt Interface (206)

This component surfaces adaptive prompts and input suggestions based on:
Inferred emotional state or behavioral deviation
Interaction stagnation or drop-off
Exploration opportunities derived from system logic or content indexing

Prompts may be fixed, templated, or generated via LLMs, and can appear in conversational, symbolic, or emotionally suggestive formats. This interface helps users refine intent, navigate ambiguity, or initiate deeper narrative arcs

### 10. Embedded Deployment Architecture

All system components are modular and may be embedded within third-party environments via:
REST or GraphQL APIs
Local SDKs
Hybrid cloud/on-device deployments

EmotionOS can run in background mode within existing platforms (e.g., music apps, streaming services, AR/VR environments, smart assistants) and provide structured output without altering the host platform's native UI

### POTENTIAL APPLICATIONS

EmotionOS may be deployed across commercial, therapeutic, and creative domains, including but not limited to:

White-label emotion engines for platforms like Spotify, Netflix, Audible, or Apple Music, enabling emotionally inferred content discovery, narrative sequencing, and symbolic playlisting.

Embedded UX layers for smart TVs, automotive infotainment, voice assistants, and IoT devices via API/SDK, activating context-aware emotional playback.

Mental health & therapeutic platforms, supporting guided emotional reframing, grief rituals, trauma processing, and self-regulation through responsive media arcs.

Franchise-specific canon optimization, e.g., The Redemption of Loki or The Rise of the Mutants (as illustrative examples only, not intended to claim or reference proprietary franchises), structuring nonlinear arcs across existing IP to increase binge engagement, deepen lore, and amplify fan retention.

Context-aware soundtrack generators for life events and mood states: weddings, breakups, ADHD hyperfocus, psychedelic journeys, post-breakdown reboots, or spiritual integration rituals.

Creative worldbuilding engines for artists, showrunners, and IP holders to design nonlinear, emotionally attuned arcs spanning music, film, podcasts, and transmedia franchises.

Interactive curatorial interfaces for immersive theater, AR/VR experiences, gamified fitness platforms, educational ecosystems, and symbolic play environments.

### KEY ADVANTAGES

Omnichannel integration: Operates across all content ecosystems (music, video, narrative, voice), unifying otherwise fragmented engagement.

Symbolic & emotionally intelligent curation: Parses not metadata, but metaphor. Interprets poetic, mythic, and psychological signals to drive output.

Cold-start intelligence: Generates resonant arcs from zero user history. No profiling. No trackers. Just signal.

Behavioral adaptation engine: Responds to micro-interactions (e.g., skips, replays, dwell time) in real time, refining trajectory without user instruction.

Infinitely scalable personalization: LLM-driven logic fuses symbolic prompts with emotional inference, generating narrative arcs uniquely personalized on demand.

Narrative-first UX architecture: Replaces feed scroll with emotional immersion. Every output has intent, closure, and psychological depth, turning passive viewers into story-driven participants.

### CONCLUSION

By reframing media discovery as a function of emotional resonance rather than metadata correlation, EmotionOS establishes a new paradigm for intelligent content sequencing, one in which symbolic input, psychological intent, and experiential outcomes drive multimedia experiences. Rather than relying on behavioral prediction or historical preferences, the system interprets emotionally and/or logically expressive input to construct deeply personal, structured narrative arcs across formats.

This invention unlocks a path toward media ecosystems that are not only personalized but emotionally meaningful, therapeutically viable, and creatively empowering by laying the foundation for a future in which user interaction is governed by internal states rather than external metrics.

### TECHNICAL SPECIFICATION ADDENDUM

EmotionOS is a modular, emotionally intelligent content sequencing system designed to operate across multiple media formats. The architecture supports both standalone deployment and embedded integration via API/SDK. The system functions without requiring prior user history, behavioral metadata, or platform-specific taxonomies.

It comprises the following primary components:

User Input Interface (201): Accepts freeform symbolic, aesthetic, natural language, or multimodal input including voice, image, and emotionally expressive text.

NLP+Emotional Inference Module (202a): Processes user input to identify emotional tone, psychological intent, symbolic structure, aesthetic markers, and desired experiential outcome using large language models (LLMs) or equivalent semantic processing systems.

Tagging & Content Structuring Layer (202b): Maps and indexes available media content using emotional, narrative, symbolic, thematic, and aesthetic tags. Creates a contextual substrate for sequence generation.

Sequence Generation Engine (202c): Assembles content into emotionally and/or logically coherent arcs using rule-based logic, affective trajectory modeling, or symbolic mapping matrices. May output sequences across one or more media formats. Central orchestrator of the system.

Smart Playback Controller (202d) (optional): Interfaces with third-party playback systems to adaptively trigger content based on sequence logic, playback state, or dynamic user conditions.

Playback Output Layer/Output Interface (203): Delivers the final media arc output in structured format (e.g., JSON, XML, proprietary schema) suitable for external playback, platform integration, or user-facing applications. May operate independently of playback control.

Behavioral Feedback Module (204) (optional): Monitors user interactions such as skips, dwell time, completion rate, or contextual factors to capture behavioral response to output sequences.

AI Curator Engine (205) (optional): Utilizes data from the Behavioral Feedback Module to refine future sequences or dynamically modify emotional arc logic. Enables adaptive learning across sessions.

Dynamic Prompt Interface (206) (optional): Offers structured or semi-structured guidance to users for more precise emotional articulation, narrative targeting, or symbolic depth. May suggest pre-defined templates, emotional triggers, or arc directionality.

### FUNCTIONAL MODULE DESCRIPTIONS

User Input Interface (201): Captures user input via text, voice, emoji, image, video, or symbolic language. Input modality may expand to include others as LLM technology evolves. Accepts structured or unstructured queries across multiple modalities. Initiates the emotional and logical inference workflow.

NLP+Emotional Inference Module (202a): Leverages transformer-based models or proprietary inference engines to extract tone, intent, mood, aesthetic signals, and experiential direction from input. Converts expressive input into structured emotional context.

Tagging & Content Structuring Layer (202b): Applies semantic and symbolic tags across content assets. Maps content according to emotional signatures, narrative arcs, symbolic weight, and aesthetic tone. Supports hybrid indexing models.

Sequence Generation Engine (202c): Constructs emotionally resonant sequences using proprietary logic models including: Emotional Arc Sequencing (EAS), Thematic Weighting Matrix (TWM), Omni-directional Chronology Framework (OCF), and Predictive Adjustment Vector (PAV).

Logic prioritizes emotional pacing, symbolic cohesion, and desired experiential outcomes over metadata or engagement statistics.

Smart Playback Controller (202d) (optional): Orchestrates sequence execution. Interfaces with playback environments.

Playback Output Layer (203): Delivers the sequenced multimedia arc in structured formats (e.g., JSON, XML, or proprietary schemas) compatible with third-party playback environments. Playback is not initiated by the system itself.

Behavioral Feedback Module (204) (optional): Captures real-time interaction data, such as skips, dwell time, and replay loops, and routes it to the AI Curator Engine for session-aware optimization.

AI Curator Engine (205) (optional): Refines future outputs based on in-session and long-term behavioral patterns. Reweights tags, adapts sequence logic, and suggests prompt personalization.

Dynamic Prompt Interface (206) (optional): An interactive frontend layer that surfaces prompts based on behavioral deviation, inferred need states, or exploration opportunities. May use fixed templates or generative LLM interaction.

### DATA HANDLING & BEHAVIOR MAPPING

EmotionOS is capable of capturing and mapping session-level behavioral signals including, but not limited to:
Skip frequency
Dwell time per content item
Replay events
Scroll interruptions or playback abandonment

Captured behavior informs both real-time (in-session) sequence modulation and cross-session personalization strategies. All behavior mapping operates without reliance on persistent user identity, account tracking, or login requirements, thereby preserving the system's core cold-start capability.

### SEQUENCE GENERATION LOGIC MODELS

EmotionOS includes a set of proprietary, modular logic frameworks for constructing emotionally and/or cognitively coherent media sequences:
EAS (Emotional Arc Sequencing): Aligns content with inferred emotional trajectory, such as despair to tension to catharsis to resolution.
TWM (Thematic Weighting Matrix): Prioritizes content based on symbolic or aesthetic density, clustering, and alignment.
OCF (Omni-directional Chronology Framework): Supports nonlinear, immersive, or retrospective ordering of content to simulate memory, evolution, or narrative depth.
PAV (Predictive Adjustment Vector): Applies adaptive logic based on observed user behavior or stated experiential goals to dynamically shift arc direction or pacing.

These logic models are modular, interoperable, and configurable based on user input, inferred affect, system goals, or integration context.

### EXAMPLE EMBODIMENTS

EmotionOS may be embodied in a range of standalone or embedded transmedia systems, including the following non-limiting implementations:
Music streaming platforms that sequence content based on natural language or symbolic emotional prompts
Video platforms that dynamically construct nonlinear arcs across TV or film libraries based on character growth, viewer affect, or thematic resonance
Audiobook applications enabling nonlinear progression based on author intent, listener reflection, or symbolic curation
Hybrid immersive systems combining music, film, podcasts, and non-media rituals (e.g., journaling, breathwork, symbolic actions) to facilitate emotional integration or therapeutic processing
These embodiments are provided as non-limiting examples in support of the claims and modular system described. This addendum clarifies the sequencing logic and delivery structure underlying EmotionOS and its initial deployment in NARRATV, the flagship application.

### GLOSSARY OF TERMS

### EmotionOS

The system and method for generating emotionally and/or logically structured multimedia sequences and transmedia narrative arcs based on user input. Encompasses all core software components, logic flows, and integration methods described herein.

### User (Broad Definition)

Any human or system-level actor interacting with EmotionOS, including individual users, content creators, platform hosts, or automated agents.

### Emotionally Expressive Input

Any input containing emotional tone, symbolic phrasing, or aesthetic nuance, such as natural language prompts, po-etic/metaphorical language, emoji sequences, images, or voice-to-text commands expressing emotional states, intentions, or desired outcomes.

### Symbolic Input

Non-literal language or imagery that conveys emotional, logical, or narrative intent. Includes metaphors, archetypes, mythic references, color symbolism, and abstract phrasing. Distinct from metadata tags due to its semantic richness and contextual sensitivity.

### Emotional Trajectory

A structured pattern of emotional movement over time (e.g., tension to catharsis to resolution). Media is sequenced to mirror or facilitate this inferred arc.

### Cold-start Condition

A state in which the system operates without prior user data, history, or metadata. All outputs are generated exclusively from interpreting the present input.

### Ritual Component

An optional non-media element presented alongside the media arc to enhance emotional resonance or closure. May include mindfulness cues, journaling prompts, symbolic gestures, environmental adjustments, or other experiential suggestions.

### Nonlinear Narrative

A media sequence arranged outside traditional chronological order. May include reverse, random, thematic, or char-acter-centric structures designed to evoke immersive or retrospective journeys.

### Multimedia Arc

A curated sequence of content assets, across formats such as music, film, podcasts, or audiobooks, structured to reflect a coherent emotional or narrative interpretation of user input.

### Natural Language Processing (NLP)

The use of AI or algorithmic models to extract emotional tone, intent, and context from human-readable language (spoken or written).

### Large Language Model (LLM)

A machine learning model trained on vast text corpora to interpret, generate, or complete human-like language. In EmotionOS, LLMs contextualize user input to drive media sequencing through creative inference.

### Emotional Arc Sequencing (EAS)

A proprietary sequencing logic that aligns media to an inferred emotional progression (e.g., dissonance to climax to release). Central to the Sequence Generation Engine.

### Thematic Weighting Matrix (TWM)

A proprietary logic model that scores and prioritizes content based on symbolic density, aesthetic tone, and emotional relevance, enabling emotionally resonant selection and ordering.

### Omni-Directional Chronology Framework (OCF)

A proprietary logic system supporting nonlinear sequencing of media assets based on user intent or thematic trajectory. Enables immersive, out-of-order, or reflective storytelling paths.

### Predictive Adjustment Vector (PAV)

A proprietary adaptive logic layer that modifies future media sequencing in response to behavioral feedback or inferred emotional needs (e.g., desire for closure, disruption, or thematic shift).

### Dynamic Prompt Interface

A UI layer that surfaces dynamic follow-up prompts, input refinements, or symbolic alternatives based on behavioral patterns, emotional deviation, or inferred experiential needs. May include generative suggestions or adaptive pathways.

### Behavioral Feedback Loop

A real-time data layer monitoring user interactions, such as skips, dwell time, and replays, routing behavior signals to the AI Curator Engine and/or Sequence Generation Engine to enable real-time arc recalibration and long-term personalization.

### Unified Nonlinear Streaming Engine

A media delivery engine capable of standalone operation or third-party integration. Constructs and delivers emotionally responsive, nonlinear media arcs across formats and platforms, enabling adaptive storytelling at scale.

### Embedded Deployment

The integration model where EmotionOS runs via SDK/API inside a third-party app. Sequencing logic operates in the background while outputs are rendered within the host platform's native interface.

### REFERENCE NUMERALS LEGEND

(100)—Action Button
(101)—Input Field
(102)—Summary/Output Overview Region
(103)—Output Item Card
(104)—Media Type Indicator
(200)—System Architecture Overview
(201)—User Input Interface
(202a)—Natural Language Processing and Emotional Inference Module
(202b)—Tagging and Content Structuring Layer
(202c)—Sequence Generation Engine
(202d)—Smart Playback Controller
(203)—Output Interface
(204)—Behavioral Feedback Module
(205)—AI Curator Engine
(206)—Dynamic Prompt Interface

What is claimed is:

1. A system for generating emotionally and/or logically structured multimedia arcs, comprising:
a user input interface configured to receive natural language input; a natural language processing module and emotional inference engine configured to infer emotional tone, psychological intent, aesthetic context, or desired experiential outcome from the input; a content sequencing engine configured to generate a structured output comprising a plurality of recommended media items, the sequencing of which is based on emotional and/or logical trajectory mapping, mood shifts, or psychological pacing intended to support transformation, resolution, or immersion; an output interface configured to present the recommended sequence in a format compatible with external playback systems, without directly initiating playback; wherein the system operates independently of content metadata, prior user behavior, or historical engagement data, but may optionally utilize such data to enhance performance; and wherein the output may further include one or more non-media action components designed to enhance emotional resonance, psychological closure, or therapeutic impact.

2. The system of claim 1, wherein the output sequence comprises one or more media items selected from at least one category including but not limited to: music tracks, albums, films, television episodes, podcasts, audiobooks, online videos, or other digital content formats; and wherein the selection of media categories is determined by the inferred intent, context, or media-type preference derived from the user input.

3. The system of claim 1, wherein the user input comprises one or more of the following: unstructured natural language; symbolic expressions; colloquial or poetic phrasing; emoji sequences; abstract emotional reflections; hyper-specific literal requests; aesthetic or sensory descriptors; stream-of-consciousness text; metaphorical or narrative-style prompts; image references; video references; multimedia cues capable of being transcribed or inferred into emotional context; and additional types of expressive input as large language model capabilities continue to evolve.

4. The system of claim 1, wherein the natural language processing module and content sequencing engine jointly determine a preferred media type or ordering of media types based on context and/or inference, and generate an output sequence that reflects a prioritized or intentional progression of formats, such as beginning with short-form content and concluding with long-form media to support emotional and/or logical pacing, immersion, or resolution.

5. The system of claim 1, wherein the output sequence includes one or more non-media action components designed to enhance emotional resonance, support psychological regulation, or complete a narrative arc, the components comprising actions such as: a recommended physical action; a breathing technique; a mindfulness or meditation practice;
a journaling or creative expression prompt; an interpersonal communication suggestion; an environmental adjustment; a sensory prompt; or any symbolic gesture or embodied activity reasonably interpreted to support emotional processing, catharsis, or integration, and to complete the user's engagement loop through embodied or symbolic closure techniques.

6. The system of claim 1, wherein the output sequence is intentionally structured to reflect a narrative arc, thematic journey, or emotional and/or logical progression, such that the selected media items and optional non-media action components are ordered to support an unfolding experience, including but not limited to: an emotional build-up and release; a guided catharsis; mood state modulation; aesthetic immersion; or the psychological closure of a specific emotional loop or internal narrative.

7. The system of claim 1, wherein the output is rendered in a structured data format for compatibility with external systems, including JSON, XML, or proprietary third-party schemas; and wherein the structured output is organized to reflect the emotional and/or logical flow, media type hierarchy, and non-media action components as distinct and orchestrated elements of a unified experience.

8. The system of claim 1, wherein the response time from receiving user input to generating a structured output sequence is dependent on the processing speed of an external large language model, and wherein the system logic is configured to produce a complete emotional arc and associated output immediately upon receipt of the processed inference.

9. The system of claim 1, wherein the content sequencing engine is configured to operate under cold-start conditions, generating emotionally and/or logically structured multimedia sequences without reliance on user history, behavioral tracking, or content metadata, while preserving the narrative coherence, psychological pacing, and experiential depth of the output.

10. The system of claim 1, wherein user input is guided by a proprietary prompt structure, comprising pre-defined, rotating, or generatively constructed language templates designed to elicit symbolic, emotionally rich input across a spectrum of tone and intent.

11. The system of claim 1, wherein the structured output is exclusively delivered via embedded deployment, including through web-based platforms, mobile applications, or API/SDK endpoints integrated into third-party systems or applications, with no direct user-facing playback or standalone media presentation functionality.

12. The system of claim 1, wherein the user input interface is configured to receive prompts in multiple modalities, including but not limited to typed text, spoken language via voice-to-text transcription, visual symbols, gestural inputs, or emotional cues extracted from images, audio, or video streams.

13. The system of claim 1, wherein the output is delivered as an interactive experience that allows the user to explore, refine, or regenerate individual elements of the curated arc, giving the user the ability to alter or maintain the overall trajectory.

14. The system of claim 1, wherein multiple distributed computing components collectively perform emotional inference, content selection, and output generation, with individual processes executed across cloud services, local devices, or on-device machine learning models.

15. A computer-implemented method for generating an emotionally and/or logically structured media sequence, comprising: receiving multimodal expressive user input via a natural language interface; parsing the input using a natural language processing model to infer tone, intent, and desired outcome; selecting one or more media items based on the inferred context; sequencing the selected media items to form an emotionally resonant arc; optionally appending one or more non-media action suggestions to the output sequence; rendering the output in a structured format compatible with external playback systems; and transmitting the output to an external playback system or interface without initiating media playback directly within the system.

16. The method of claim 15, wherein the user input is processed by an external large language model and the emotional inference is derived from the returned structured result.

17. The method of claim 15, wherein the system operates in cold-start conditions without access to prior user data, content metadata, or historical usage patterns.

18. The method of claim 15, wherein the output sequence is dynamically regenerated in part or in whole based on user interaction or preference input, while maintaining the current trajectory or allowing altered trajectory.
